(19) United States
(12) Patent Application Publication
(10) Pub. No.: US 2014/0360993 A1
(43) Pub. Date: Dec. 11, 2014

(54) MULTI-FUNCTION AND MULTI-VEHICLE-TYPE ROBOT APPARATUS FOR COMMON USE

(71) Applicant: Hyundai Motor Company, Seoul (KR)

(72) Inventor: Jung Whan YEUM, Whasung-Si (KR)

(73) Assignee: Hyundai Motor Company, Seoul (KR)

(21) Appl. No.: 14/281,499

(22) Filed: May 19, 2014

(30) Foreign Application Priority Data
Jun. 11, 2013 (KR) 10-2013-0066818

(51) Int. Cl. B23K 37/02

(52) U.S. Cl. CPC B23K 37/0258; B23K 37/02; Y10S 901/42
USPC 219/125.1; 901/42

(57) ABSTRACT

A multi-function and multi-vehicle-type common-use robot apparatus may include a robot; a frame attached to an arm of the robot; a plurality of sliders assembled to the frame to slide in a predetermined direction, and a common-use unit which includes an upper welding gun, a lower welding gun, and a component that performs a part-holding gripper and which is mounted on each slider, such that a position of the common-use unit is controlled in the frame.

### CROSS-REFERENCE TO RELATED APPLICATION

The present application claims priority to Korean Patent Application No. 10-2013-0066818 filed on Jun. 11, 2013, the entire contents of which is incorporated herein for all purposes by this reference.

### BACKGROUND

1. Field of the Invention

The present disclosure relates to a multi-function and multi-vehicle-type robot apparatus for common use, and more particularly, to a multi-function and multi-vehicle-type robot apparatus which may be used in common for vehicle body assembling processes of various vehicle types and may also perform a grip function and a welding function for vehicle body parts.

2. Description of Related Art

Generally, vehicles are manufactured by assembling a number of parts through various processes such as an assembling process or a welding process.

In particular, to assemble a vehicle body assembly in mass production of vehicles, a welding process for spot-welding and bonding multiple vehicle body panels or a hemming process for rolling and bending edges of the panels bonded in the welding process is performed.

In the vehicle body assembling process of vehicle mass production, vehicle body panels produced by a press process are manufactured by welding. In this case, the parts may be held by a gripper or a clamp or may be set in a jig for an assembling or processing operation.

Conventionally, after a gripper dedicated for a corresponding vehicle type is manufactured, the gripper is exchanged according to a vehicle type by using an auto tool changer.

However, since a gripper is used for a long time, if the dedicated gripper is used in mixed-type production for various vehicle types, it is not suitable for a feature of a production line that needs high productivity.

To solve this problem, a need for technology development of a common gripper that may be used regardless of size and shape of a vehicle body panel of each vehicle type is increasing more and more, and much research has been conducted to implement the common use of a gripper for automobile companies.

Meanwhile, a technique for mounting and using a spot welding device for a vehicle body assembling process and a gripper for holding parts such as a vehicle body panel in the vehicle body assembling process in a robot has been widely known.

In a conventional welding process, continuous welding has to be performed along a plurality of welding points, consuming much time and complicating a process. As an approach to automate a process for reducing a welding time and improving productivity, efficiency, and welding quality, a robot welding system is widely used in which a welding device is attached to a robot and a spot position is moved by an operation of the robot for welding.

In addition, a robot gripper system is also widely used in which a gripper device is attached to an end of a robot to transfer a vehicle body part or hold a vehicle body part and fix a position in a welding or sealing operation.

The robot welding system or the robot gripper system is often used to manufacture or transfer a side assembly or a tailgate of left and right sides of the vehicle body.

FIG. 1 is a perspective view of a conventional robot gripper system 10a manufactured for each vehicle type, in which an example of the robot gripper system 10a for a tailgate is shown. FIG. 2 is a perspective view of a clamp dedicated for each vehicle type (a dedicated pneumatic clamp) 3 and a pneumatic sliding device (a sliding cylinder) 5 of a gripper device 2 in the robot gripper system 10a of FIG. 1.

In the shown conventional robot gripper system 10a, due to variations in a holding angle of a vehicle body part and a size of the body part among vehicle types, a dedicated unit developed for each vehicle type is used.

That is, the dedicated gripper device 2 capable of performing a grip operation (an operation of holding a part) by using a dedicated unit such as the dedicated clamp 3 and pneumatic sliding device 5 for each vehicle type, in which a plurality of dedicated clamps 3 driven by an actuator 4 and the pneumatic sliding device 5 are disposed in proper places of a frame 6 according to a vehicle type, and then the dedicated gripper device 2 is mounted in an end (arm) of the robot 1 to configure the dedicated robot gripper system 10a.

In this case, along with the use of the dedicated clamp corresponding to each vehicle type, the shape, position, and number of dedicated clamp 3 and pneumatic sliding device 5 may vary according to the corresponding vehicle type, thus configuring the dedicated robot gripper system 10a.

FIG. 3 is a perspective view of a robot welding system 10b in which a stop welding device 7 for welding and coupling vehicle body parts is attached to an end (arm 1a) of the robot 1.

As such, conventionally, the dedicated robot gripper system 10a and the dedicated robot welding system 10b are separately provided for each vehicle type, and as in the system illustrated in FIGS. 1 and 3, the dedicated gripper device 2 and the spot welding device 7 for each vehicle type are attached to the dedicated individual robot 1.

Therefore, conventionally, separate spaces are required for installing each respective robot, and welding and gripper operations are sequentially required, increasing a cycle time of processing.

FIGS. 4 through 7 are diagrams for describing problems of a conventional gripper system. For a dedicated gripper, as illustrated in FIG. 4, if angles θ₁ and θ₂ of restricted cross-sections of vehicle body parts are different for vehicle types A and B, or as illustrated in FIG. 5, if heights of restricted cross-sections of vehicle body parts are different for vehicle types A and B, or as illustrated in FIG. 6, if shapes of holding cross-sections of vehicle body parts are complicated, or as illustrated in FIG. 7, if avoidance of interference with existing facilities is necessary, dedicated clamp and pneumatic sliding device are applied for each vehicle type.

If a new vehicle type cannot be satisfied through addition of dedicated pneumatic clamp and sliding cylinder, the entire gripper device 2 is newly manufactured for the new vehicle type.

However, when a dedicated unit, such as the dedicated clamp 3 or pneumatic sliding device 5, or the dedicated gripper device 2 including the dedicated unit, is used, additional cost incurs due to reconstruction and manufacturing for a new vehicle type, increasing investment cost and complicating the entire configuration of the robot gripper system 10a.

Since the shape of an end, that is, a welding tip 9, of welding guns 8a and 8b in the conventional robot welding system 10b illustrated in FIG. 3 is in a semispherical shape of a fixed type (rotation is not possible) as illustrated in FIG. 8, variations in shape or angle of a part cross-section for each vehicle type cannot be handled, and thus when the robot welding system 10b is used, the part may be deformed.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a multi-function and multi-vehicle-type robot apparatus for common use, which may be used in common in a vehicle body assembling process of various vehicle types for use in multiple vehicle types and may be usefully used in mixed-type production for multiple vehicle types.

The present invention also provides a multi-function and multi-vehicle-type robot apparatus for common use, which is configured to perform a grip function and a welding function for vehicle body parts and thus has a simple structure in which conventional robot welding system and gripper system are integrated.

In an aspect of the present invention, a multi-function and multi-vehicle-type common-use robot apparatus may include a robot, a frame attached to an arm of the robot, a plurality of sliders assembled to the frame to slide in a predetermined direction, and a common-use unit which may include an upper welding gun, a lower welding gun, and a component that performs a part-holding gripper and which is mounted on each slider, such that a position of the common-use unit is controlled in the frame.

The multi-function and multi-vehicle-type common-use robot apparatus may further include a moving device for moving each slider to a target position to control a position of the slider according to a control signal of a control panel.

The component that performs the part-holding gripper may include the upper welding gun and the lower welding gun, and wherein the upper welding gun and the lower welding gun perform the part-holding gripper by simultaneously pressurizing and fixing a vehicle body part in both sides thereof.

A welding tip of each of the upper welding gun and the lower welding gun of the common-use unit performs the part-holding gripper as well as a spot welding.

The welding tip of the upper welding gun is installed to rotate according to angle and shape of the vehicle body part.

The welding tip of the upper welding gun may include a rotatably coupled rotating pad.

The welding tip of the upper welding gun is configured by forming an engagement portion in a welding rod of the upper welding gun and rotatably coupling the rotating pad to the engagement portion.

The rotating pad is coupled to the engagement portion in a ball-joint structure.

The engagement portion is provided in a form of a ball in the ball-joint structure, such that the rotating pad is coupled to the engagement portion in the form of the ball.

The welding tip of the lower welding gun is installed to rotate according to angle and shape of a vehicle body part.

The welding tip of the lower welding gun may include a rotatably coupled rotating pad.

The welding tip of the lower welding gun is configured by forming an engagement portion in a front end portion of a gun arm of the lower welding gun and rotatably coupling the rotating pad to the engagement portion.

The rotating pad is coupled to the engagement portion in a ball-joint structure.

The frame is in a shape of ‘⊥’ formed by integrally coupling a first sub-frame disposed long in a vertical direction and a second sub-frame disposed long in a horizontal direction, and a slider is installed in at least one of the first sub-frame disposed long in the vertical direction and the second sub-frame disposed long in the horizontal direction.

A plurality of sliders are installed in the first and second sub-frames disposed long in each direction to slide along a longitudinal direction of the first and second sub-frames, and the common-use unit is mounted integrally in each slider to linearly move.

Two common-use units are mounted in both sides of the second sub-frame via a first slide to move in the horizontal direction, and one common-use unit is mounted in the first sub-frame via a second slide to move in the vertical direction, such that at least three common-use units moving in the horizontal direction and in the vertical direction are provided.

The moving device may include a motorized linear cylinder tool for moving the slider, and a linear motion (LM) guide that is fixedly mounted in the frame and coupled to the slider to guide forward and backward sliding of the slider in driving of the motorized linear cylinder tool.

The motorized linear cylinder tool may include a motor that is driving-controlled according to a control signal of the control panel, a screw shaft that rotates by driving of the motor, and a cylinder rod coupled to the screw shaft in a state where the slider is mounted in a front end portion to move forward and backward in rotation of the screw shaft.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of a conventional robot gripper system manufactured for each vehicle type.

FIG. 2 is a perspective view of conventional dedicated clamp and pneumatic sliding device for each vehicle type, which constitute a gripper device.

FIG. 3 is a perspective view of a conventional robot welding system in which a spot welding device for welding and coupling a vehicle body part is attached to an end of a robot.

FIGS. 4 through 7 are diagrams for describing problems of a conventional gripper system.

FIG. 8 is a diagram illustrating structure and shape of a welding tip in a conventional robot welding system.

FIG. 9 is a perspective view illustrating a structure of a multi-function and multi-vehicle-type robot apparatus for common use according to an exemplary embodiment of the present invention.

FIG. 10 is a perspective view illustrating a multi-vehicle-type corresponding frame having a moving device mounted thereon separately from a multi-function and multi-vehicle-type robot apparatus for common use according to an exemplary embodiment of the present invention.

FIG. 11 is a perspective view separately illustrating a moving device from a multi-function and multi-vehicle-type robot apparatus for common use according to an exemplary embodiment of the present invention.

FIG. 12 is a perspective view illustrating a welding and part holding common-use unit in a multi-function and multi-vehicle-type robot apparatus for common use according to an exemplary embodiment of the present invention.

FIG. 13 is a partially-cut perspective view illustrating a rotational structure of a welding tip in a common-use unit in a multi-function and multi-vehicle-type robot apparatus for common use according to an exemplary embodiment of the present invention.

FIGS. 14 and 15 are perspective views showing a use state of a multi-function and multi-vehicle-type robot apparatus for common use according to an exemplary embodiment of the present invention.

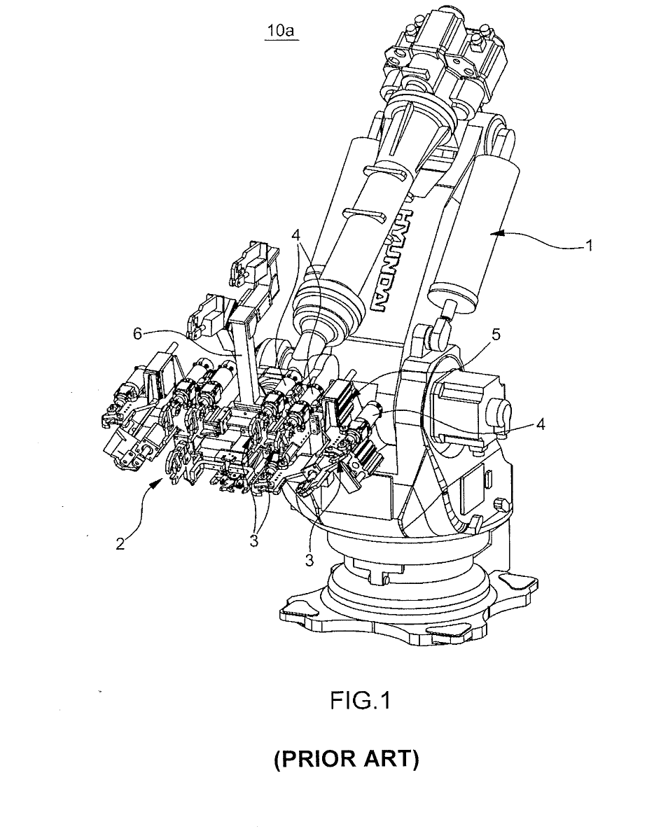

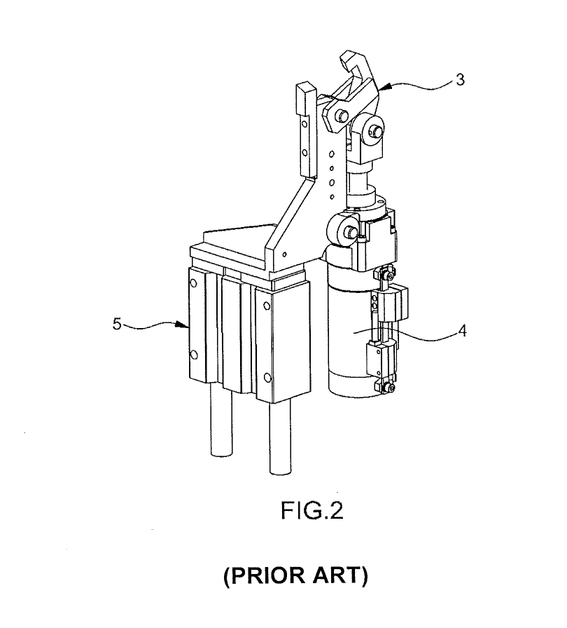

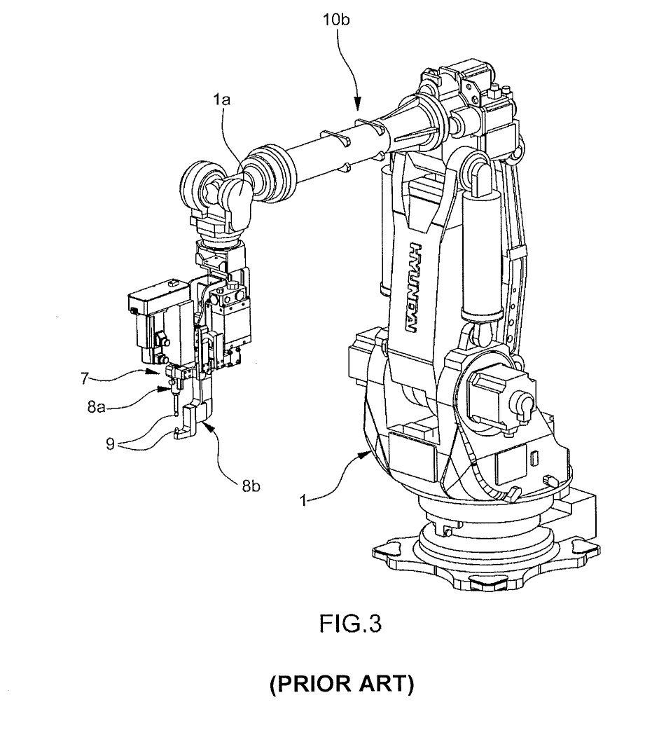

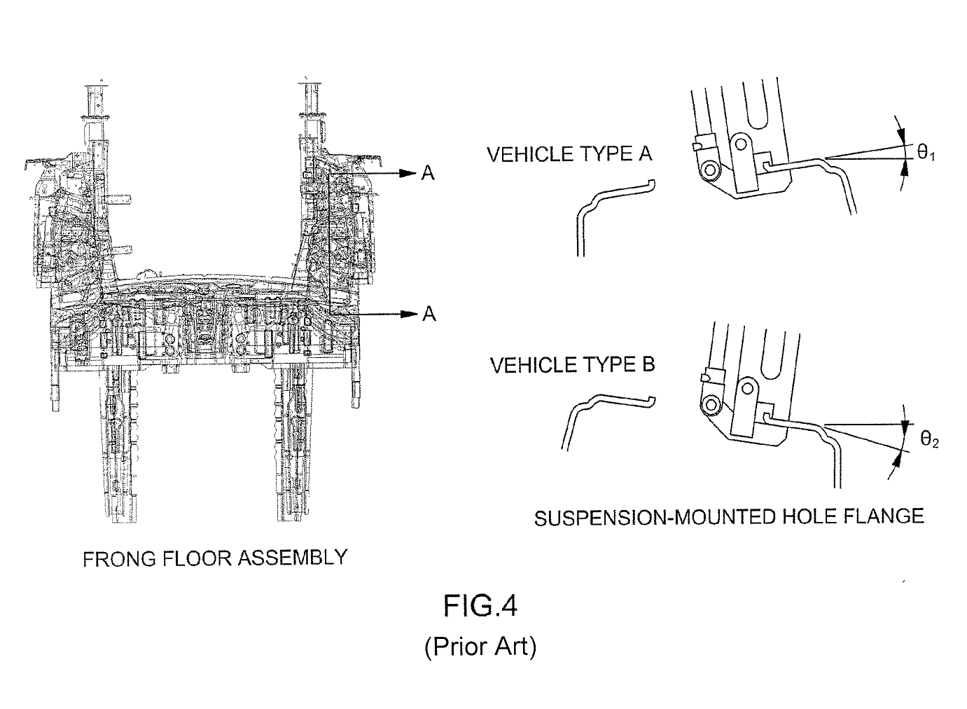

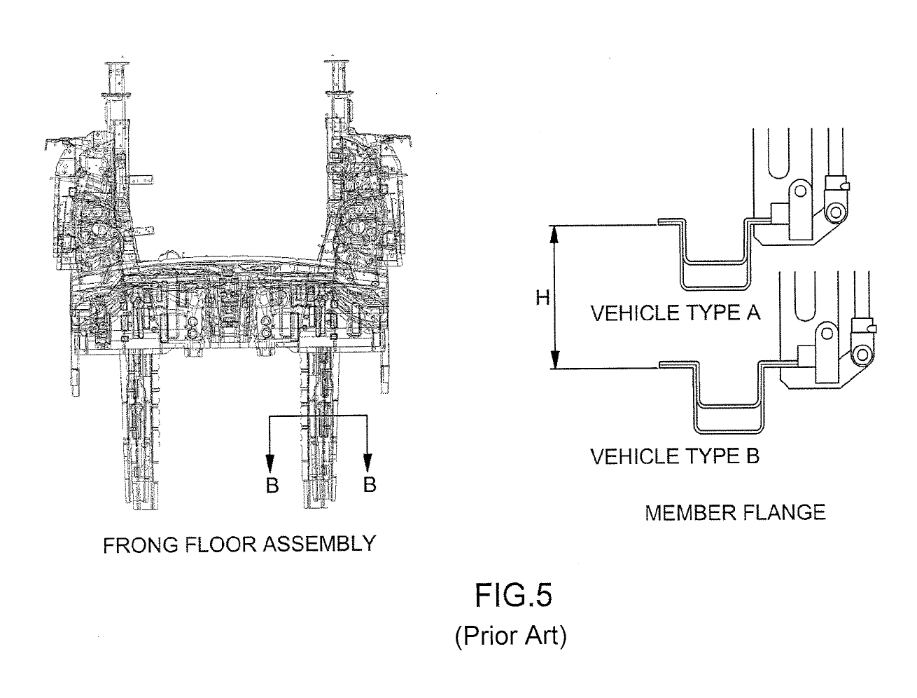

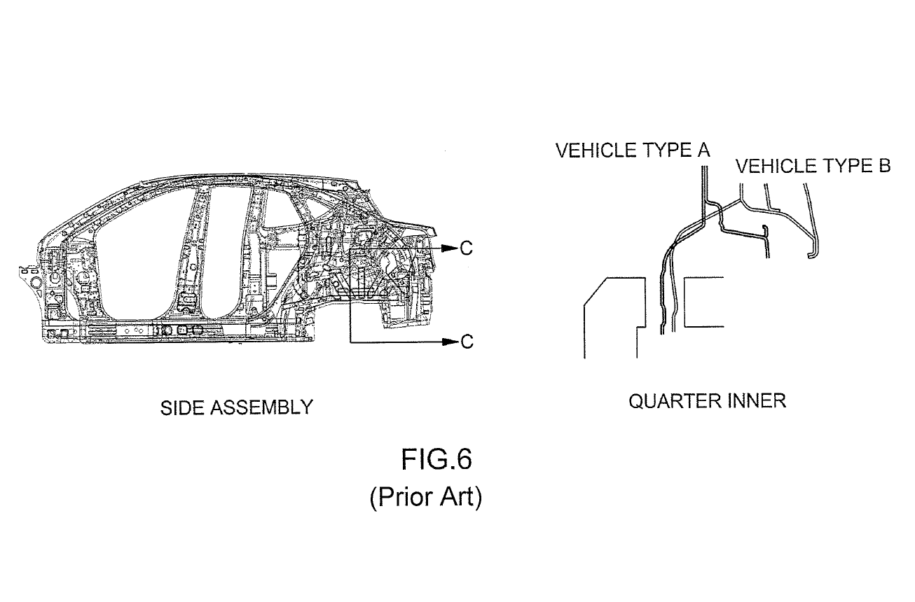

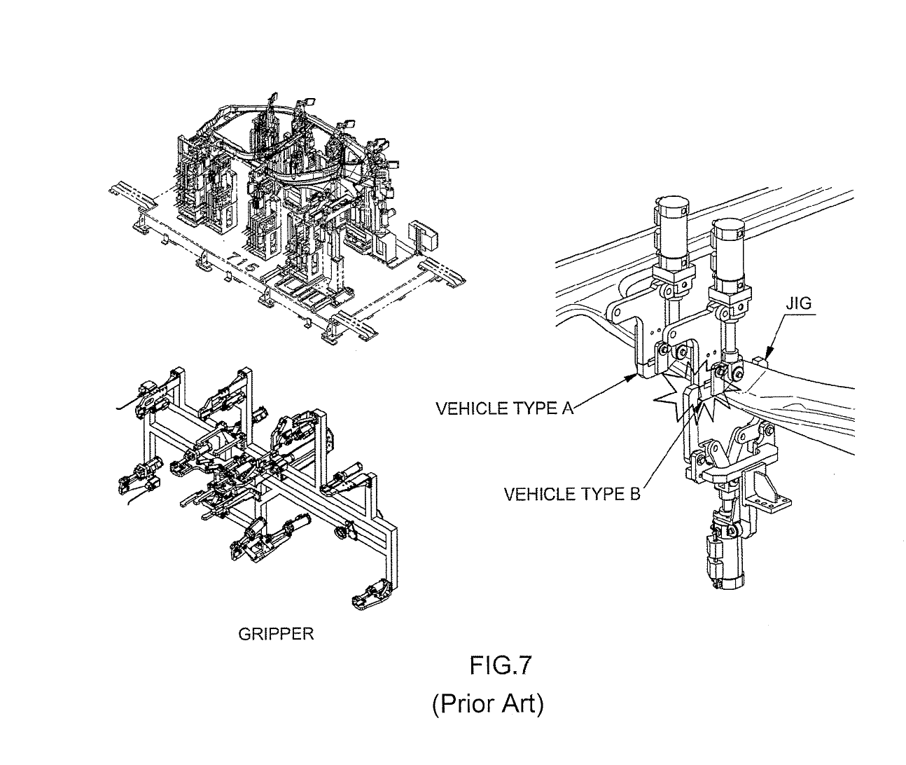

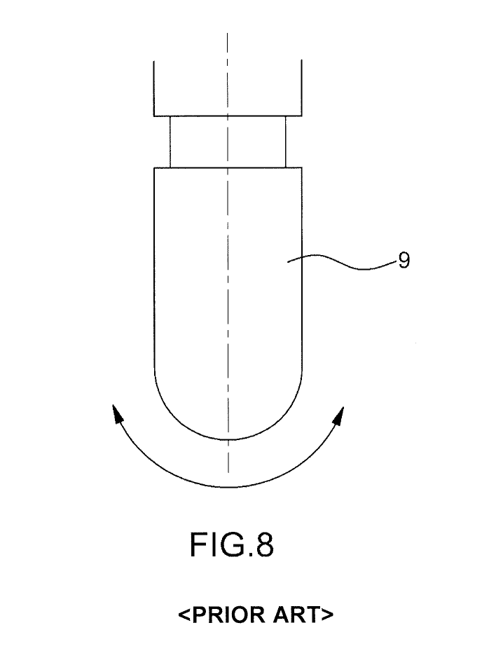

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, the present invention will be described in detail with reference to the accompanying drawings to allow those of ordinary skill in the art to easily carry out the present invention.

The present invention relates to a multi-function and multi-vehicle-type robot apparatus for common use (or a multi-function and multi-vehicle-type common-use robot apparatus), which may be used in common in a vehicle body assembling process of various vehicle types and may also perform a grip function and a welding function for a vehicle body part.

In particular, a multi-function and multi-vehicle-type common-use robot apparatus according to an exemplary embodiment of the present invention especially includes a part holding gripper for holding a vehicle body part to fix the position of the part when the part is transferred or welded or sealed, and a plurality of common-use units capable of functioning as a welder for welding and bonding the vehicle body part.

In addition, a multi-function and multi-vehicle-type common-use robot apparatus according to an exemplary embodiment of the present invention includes a moving device capable of moving a common-use unit for welding and part holding (or a welding and part holding common-use unit) to cope with variations in vehicle body part size among various vehicle types, and a welding tip (which is also a contacting grip tip for holding a vehicle body part) of the welding and part holding common-use unit is provided as a swivel type for use in vehicle body parts of various vehicle types.

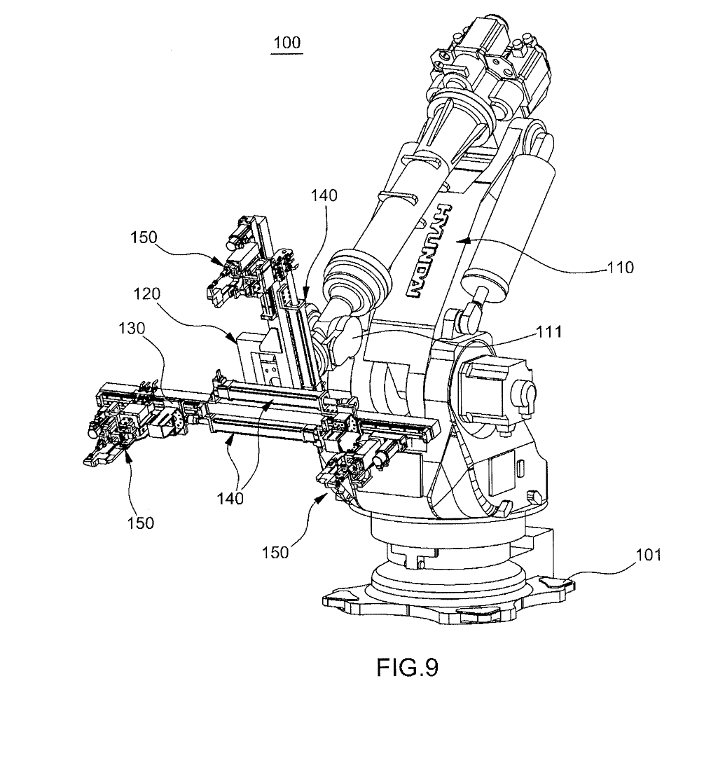

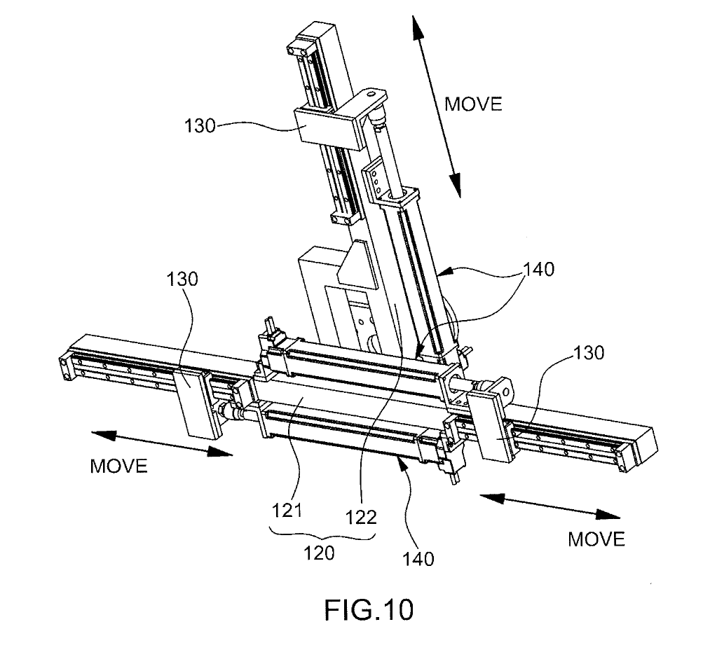

FIG. 9 is a perspective view of a multi-function and multi-vehicle-type common-use robot apparatus 100 according to an exemplary embodiment of the present invention. FIG. 10 is a perspective view of a multi-vehicle-type corresponding frame 120 having a moving device mounted thereon in the multi-function and multi-vehicle-type common-use robot apparatus 100 according to an exemplary embodiment of the present invention.

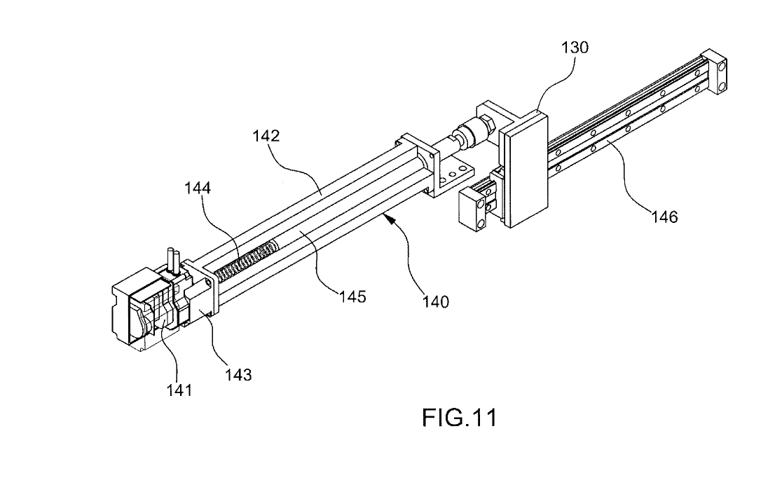

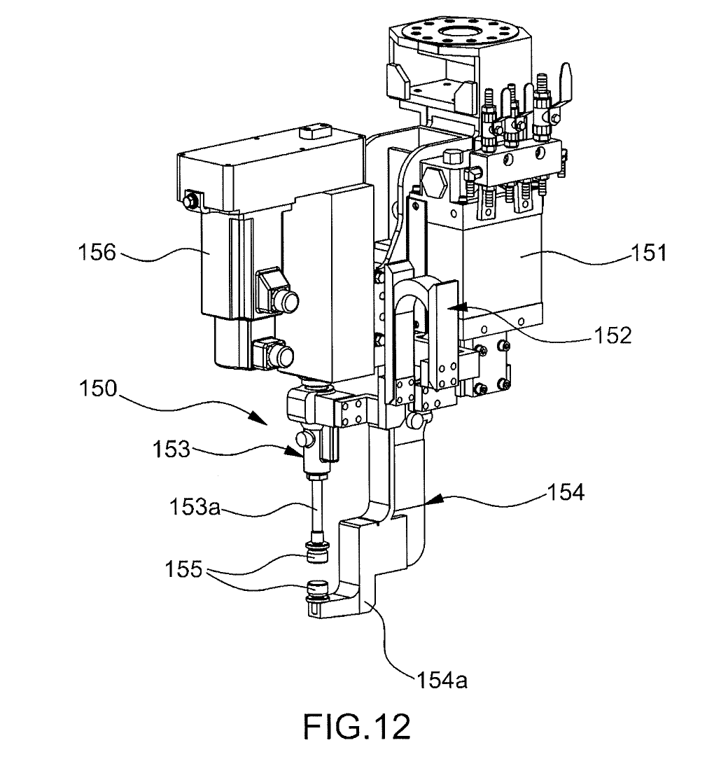

FIG. 11 is a perspective view separately illustrating a moving device from the multi-function and multi-vehicle-type common-use robot apparatus 100 according to an exemplary embodiment of the present invention. FIG. 12 is a perspective view illustrating the welding and part holding common-use unit 150 in the multi-function and multi-vehicle-type common-use robot apparatus 100 according to an exemplary embodiment of the present invention.

As illustrated, the multi-function and multi-vehicle-type common-use robot apparatus 100 includes a multi-joint robot 110 mounted to rotate on a base 101 fixed in an installation place, a frame 120 attached to a rotatable arm 111 of the robot 110, a plurality of sliders 130 assembled on the frame 120 to slide in respective predetermined directions, a moving device driven according to a control signal of a control panel to move each slider 130 to a target position in the frame 120 for control of the position of each slider 130, and the common-use unit 150 that has components of a spot welder including an upper welding gun 153 and a lower welding gun 154 and is mounted in each slider 130 such that the position of the frame 120 is controlled.

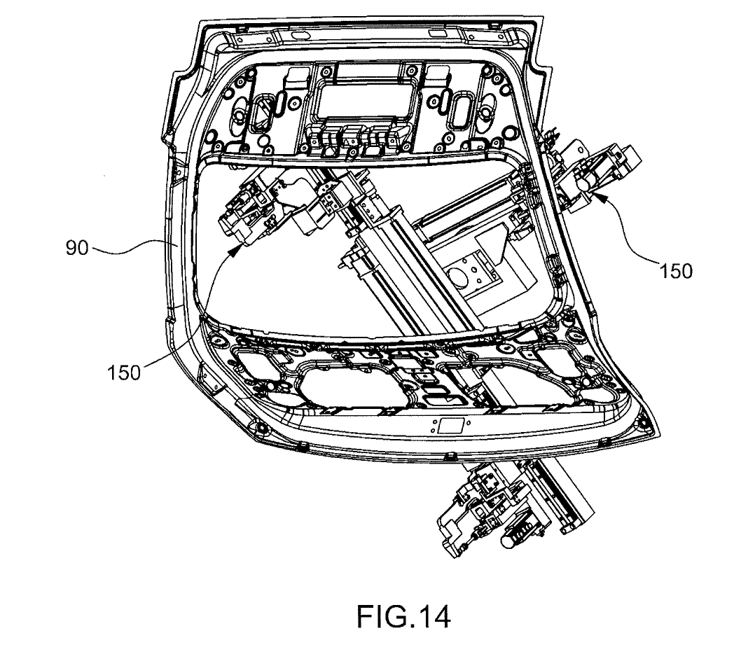

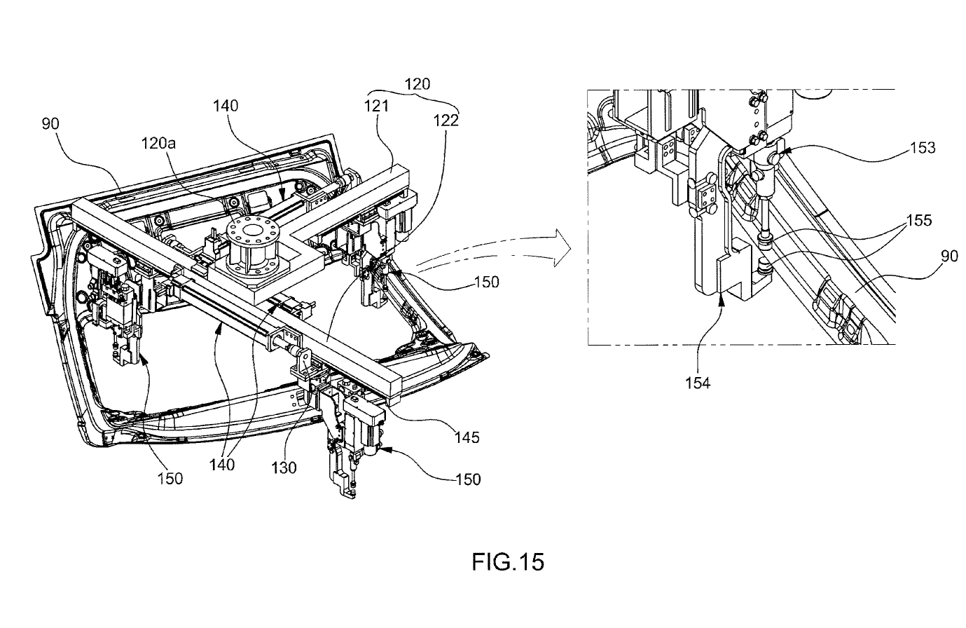

Herein, to function both as a gripper for part holding and a spot welder for part bonding, the common-use unit 150 includes components of the spot welder, such as a transformer 151, a booth bar 152 and a shunt, the upper welding gun 153 and the lower welding gun 154 having respective welding tips 155, and a pressurizing servo actuator 156, and the upper welding gun 153 and the lower welding gun 154 may also be used as part holding grippers for holding and fixing a vehicle body part, for example, a vehicle body panel (90 in FIGS. 14 and 15) in upper and lower sides.

When the upper welding gun 153 is lowered with an operation of the pressurizing servo actuator 156, the upper welding gun 153 and the lower welding gun 154, which function as a gripper, more clearly, the welding tip 155 of the upper welding gun 153 and the welding gun 155 of the lower welding gun 154 positioned in the lower side to correspond to the upper welding gun 153 actually contact the vehicle body part 90 to hold the vehicle body part 90 in the upper and lower sides. In this case, each welding tip 155 functioning as the gripper is provided as a swivel type to rotate on the corresponding welding gun.

Also, as illustrated in FIGS. 9 and 10, the frame 120 engaged to the arm 111 of the robot 110 through an engagement unit (120a of FIG. 15) is made by integrally assembling sub-frames 121 and 122 that are disposed longitudinally in an up-down (vertical) direction and in a left-right (horizontal) direction, respectively, such that the frame 120 has an overall shape of ‘⊥’.

In the sub-frames 121 and 122 disposed in corresponding directions, the plurality of sliders 130 which linearly slide along longitudinal directions of the sub-frames 121 and 122 are installed, and the common-use unit 150 is engaged and mounted on each slider 130 to linearly move together with the slider 130.

That is, the slider 130 linearly moves along the longitudinal direction of each of the sub-frames 121 and 122 by means of each moving device, and the common-use unit 150 also linearly moves together with movement of the slider 130, such that the positions of the slider 130 and the common-use unit 150 integrally assembled may be variable-controlled variously according to the longitudinal direction of each of the sub-frames 121 and 122.

FIG. 10 is a perspective view illustrating the multi-vehicle-type corresponding frame 120 having a moving device mounted thereon separately from the multi-function and multi-vehicle-type common-use robot apparatus 100 according to an exemplary embodiment of the present invention, in which the plurality of sliders 130 linearly moving along the sub-frames 121 and 122 are installed and the same number of moving devices for linear movement of the respective sliders 130 are installed in each of the sub-frames 121 and 122.

Herein, the moving device may be a linear-moving device driven according to a control signal of an external control panel, and may include a motorized linear cylinder tool 140 in which a cylinder rod 145 moves forward and backward with driving of a motor 143 as illustrated in FIG. 11.

That is, each moving device includes the motorized linear cylinder tool 140 and a linear motion (LM) guide 146 which is fixed and mounted on each of the sub-frames 121 and 122 to guide forward or backward sliding of the slider 130 in driving of the motorized linear cylinder tool 140. Herein, the motorized linear cylinder tool 140 includes a motor 143 whose driving is controlled by a control signal of a control panel, a screw shaft 144 which rotates by driving of the motor 143, and the cylinder rod 145 which is coupled to the screw shaft 144 to move forward and backward in rotation of the screw shaft 144 when the slider 130 is mounted on a front-end portion.

In an exemplary embodiment illustrated in FIGS. 10 and 11, the cylinder rod 145 is coupled to the screw shaft 144 embedded in a housing 142 to receive a rotating force in rotation of the screw shaft 144 and straight-linearly move, in which the screw shaft 144 and the cylinder rod 145 transform a rotating force of the motor 143 into straight-linear movement and in this case, the cylinder rod 145 is provided to move forward and backward without rotating in the housing 142.

That is, the cylinder rod 145 is a load whose rotation is restricted and whose forward and backward linear movement is only possible in a state where a portion of the load is embedded inside the housing 142.

In an exemplary embodiment of FIG. 11, reference numeral 141 is an encoder 141 for driving the motor 143 according to the control signal of the control panel, such that the motor 143 is rotation-driven with an output of the encoder 141 that receives the control signal of the control panel (a position control signal corresponding to a vehicle type) in the motorized linear cylinder tool 140. In this case, the driving force of the motor 143 is transformed into a straight-linear-moving force of the cylinder rod 145 through the screw shaft 144, and eventually, due to forward and backward movement of the cylinder rod 145, the slider 130 linearly moves along the LM guide 146.

In FIG. 10, the horizontal sub-frame 121 and the vertical sub-frame 122 are coupled to form the frame 120 having the overall shape of ‘⊥’, such that the LM guides 146 are fixedly installed in both end portions of the horizontal sub-frame 121 and one end portion of the vertical sub-frame 122, respectively.

In this case, the sliders 130 whose linear movement is guided along the longitudinal directions of three LM guides 146 are coupled to the three LM guides 146, respectively (a total of three sliders are provided), and three motorized linear cylinder tools 140 are mounted on the sub-frames 121 and 122 and thus the respective cylinder rods 145 are coupled to the corresponding sliders 130, respectively.

As a result, as driving of the motor 143 is controlled, the forward and backward movement positions of the cylinder rod 145 are controlled, and in this case, the position of each slider 130 and the position of the common-use unit 150 engaged and mounted on each slider 130 are controlled along the LM guides 146. Thus, the common-use unit 150 may be moved and controlled to prescribed welding position and restricted position (grip position) with respect to a vehicle body part (90 in FIGS. 14 and 15) of a corresponding vehicle type.

In particular, the rotating position of the rotatable arm 111 is controlled in the robot 110, and the position of each common-use unit 150 is controlled by the moving device, such that the grip position and the welding point with respect to the vehicle body part 90 set by the position of the common-use unit 150 may be adjusted variously.

The common-use unit 150 includes components of a well-known spot welder for example, the transformer 151, the booth bar 152 and the shunt, the upper welding gun 153 and the lower welding gun 154 having the respective welding tips, and the pressurizing servo actuator 156. In an exemplary embodiment of the present invention, the welding tips 155 of the upper welding gun 153 and the lower welding gun 154 perform not only a welding function, but also a grip function of holding the vehicle body part 90 in the upper and lower sides.

The common-use unit 150 has a frame integrally engaged to the slider 130, and in this frame, the transformer 151 is fixedly installed to transform high voltage/high current of a primary side into high voltage/high current of a secondary side.

In addition, the booth bar 152 and the shunt are provided to conduct the secondary-side current of the transformer 151 to the welder. To allow supply of the secondary side applied from the transformer 151 to the welder, one side of the booth bar 152 is connected to the transformer 151 at all times and in this case, another side of the booth side 152 is connected to the welder. In this way, the output end of the transformer 151 and the upper welding gun 153 of the welder, and the output end of the transformer 151 and the lower welding gun 154 of the welder are electrically connected to each other.

In addition, the pressurizing servo actuator 156 for lowering the upper welding gun 153 is installed in the frame 120 of the common-use unit 150 such that when the vehicle body part 90 is welded or gripped, the upper welding gun 153 is lowered to pressurize the vehicle body part 90 from the upper side.

The pressurizing servo actuator 156 is a component for generating a welding pressurizing force, and may be a motorized actuator which transforms the rotating force of the motor 143 into a straight-linear moving force and urges linear-movement of the welding gun 153 to pressurize the vehicle body part 90.

As such, the common-use unit 150 has main components of a well-known spot welder, that is, the transformer 151 for power supply and vehicle body part pressurization and welding, the booth bar 152 and the shunt, the upper welding gun 153 and the lower welding gun 154 having the respective welding tips 155, and the pressurizing servo actuator 156, and any well-known component necessary for performing spot welding in the spot welder may also be used.

The common-use unit 150 illustrated in FIG. 12 is an example that may be used in an exemplary embodiment of the present invention. However, common-use units of various forms, which basically have structures like a spot welder, may be used in an exemplary embodiment of the present invention as long as they include components such as the upper welding gun 153 and the lower welding gun 154 that are pressurization and conduction elements. Moreover, without any restriction in terms of structure, various forms modified from the example of FIG. 12 may also be used.

However, in an exemplary embodiment of the present invention, the upper welding gun 153 and the lower welding gun 154 of the common-use unit 150 are components which perform a spot welding function through pressurization and conduction with respect to the vehicle body part 90 and also pressurize the vehicle body part 90 to fix the vehicle body part 90 together with conduction, thus also functioning as grippers for the vehicle body part 90.

That is, in an exemplary embodiment of the present invention, the upper welding gun 153 in the upper side and the lower welding gun 154 positioned in the lower side to correspond to the upper welding gun 153 may also be used as components of the gripper for transferring the vehicle body part 90 and holding the vehicle body part 90 to fix the position of the vehicle body part 90 in welding and sealing. In particular, the welding tip 155 is installed to rotate according to the angles and shapes of a holding cross-section and a welding cross-section of the part to correspond to various vehicle body parts 90 of various vehicle types.

Thus, the common-use unit 150 according to an exemplary embodiment of the present invention is a multi-function and multi-vehicle type common-use component which performs both a welding function of the vehicle body part 90 and the holding function of the vehicle body part 90.

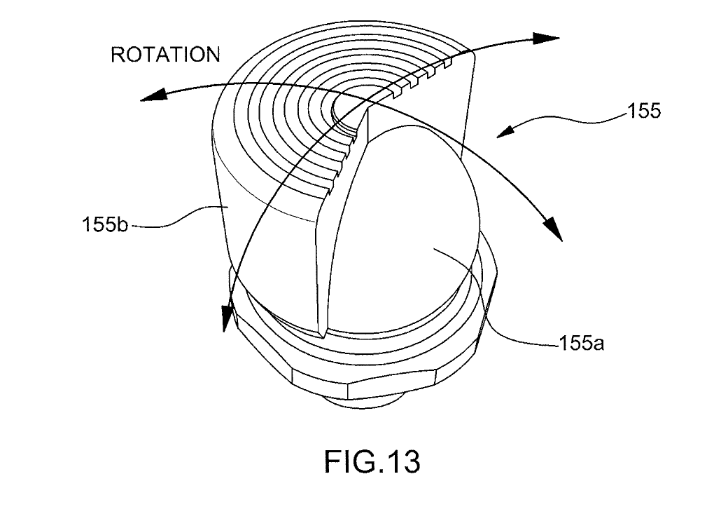

FIG. 13 is a partially-cut perspective view showing a rotatable structure (swivel structure) of the welding tip 155 in the common-use unit 150 of the multi-function and multi-vehicle-type common-use robot apparatus 100 according to an exemplary embodiment of the present invention, in which the desirable swivel-type welding tip 155 is shown.

As is shown, the welding tips 155 of the upper welding gun 153 and the lower welding gun 154 include a rotating pad 155b mounted to rotate on a restricted surface with respect to the vehicle body part 90.

That is, the welding tips 155 of the welding guns 153 and 154 in the upper and lower sides include engagement portions 155a in the shape of balls formed in a welding rod 153a of the upper welding gun 153 and a front-end portion of a gun arm 154a of the lower welding gun 154 and the rotating pads 155b which are coupled to the engagement portions 155a in a ball-joint manner and rotate according to the angle and shape of the vehicle body part 90.

The engagement portions 155a and the rotating pads 155b of the welding tips 155 are formed of conductive materials, and in this case, the rotating pads 155b serve as welding tips of a spot welder which contact the vehicle body part 90 for conduction and pressurization of the vehicle body part 90 and also form a restricted surface of a gripper function which fixes and restricts the vehicle body part 90 through pressurization.

In particular, in the common-use unit 150 of the present invention, the rotating pads 155b which serve as the welding tips and form a restricted surface for the vehicle body part 90 in the grip function are provided to rotate in the engagement portions 155a in the shape of balls, such that since the shape of a part such as a vehicle body panel, or the shape or angle of the restricted cross-section varies according to a vehicle type, when the rotating pads 155b pressurize the vehicle body part 90, the rotating pads 155b rotate in the engagement portions 155a according to the shape and angle of the part 90, thus preventing deformation of the vehicle body part 90.

The multi-function and multi-vehicle-type common-use robot apparatus 100 according to an exemplary embodiment of the present invention has been described so far. FIGS. 14 and 15 are perspective views illustrating the use state of the multi-function and multi-vehicle-type common-use robot apparatus 100 according to an exemplary embodiment of the present invention.

FIG. 14 shows a state when a gripper function is performed, in which in each common unit 150, the upper welding gun 153 and the lower welding gun 154 pressurize and fix the vehicle body part 90 in the upper and lower sides. As is shown, each common-use unit 150 transfers the vehicle body part 90 and functions as a gripper for holding the vehicle body part 90 to fix the position of the vehicle body part 90 in welding and sealing.

If a control signal for controlling driving of each moving device is delivered from a control panel for such an operation, that is, if a position control signal corresponding to a vehicle type is delivered to the encoder 141 from the control panel, the motor 143 of the moving device is driven by the output of the encoder 141 to move the slider 130 to a predetermined position, such that the common-use unit 150 engaged with the slider 130 moves to a prescribed grip position (restricted position) with respect to the vehicle body part 90 of a corresponding vehicle type.

In addition, the upper welding gun 153 and the lower welding gun 154, which are part-holding components in each of the plurality of common-use units 150, operate in each grip position to closely pressurize the vehicle body part 90 in the upper and lower sides, such that the vehicle body part 90 may be fixed by the plurality of common-use units 150.

FIG. 15 illustrates a state when a welding function is performed, in which after the common-use unit 150 moves to a prescribed welding target point, the welding tips 155 of the upper welding gun 153 and the lower welding gun 154 contact the vehicle body part 90, and then pressurization and conduction are performed according to a welding control signal of the control panel, thus completing spot welding.

In this case, selective driving may be performed such that when some of the common-use units 150 hold the vehicle body part 90, another common-use units 150 may weld the vehicle body part 90.

Although not shown in FIG. 15, a separate jig apparatus for stably fixing and supporting the vehicle body part 90 may be provided in the lower side, such that when the vehicle body part 90 in the upper side is fixed and supported by the jig apparatus in the lower side, all or some of the common-use units 150 move to a predetermined welding target point and then the vehicle body part 90 whose position is fixed by the jig apparatus may be spot-welded.

The structure and operating state of the multi-function and multi-vehicle-type common-use robot apparatus 100 according to an exemplary embodiment of the present invention have been described so far, and the multi-function and multi-vehicle-type common-use robot apparatus 100 is configured as an integrated system which includes the common-use unit 150 that function as both a part holding gripper for transferring the vehicle body part 90 or fixing the position of the vehicle body part 90 in welding or sealing and a welder for welding and bonding the vehicle body part 90, thereby reducing the number of robots and installation spaces of robot/welder/gripper when compared to a conventional case in which a robot grip system and a robot welding system are separately provided.

The plurality of common-use units 150 selectively perform grip and welding operations, thus reducing a cycle time of processing when compared to a conventional system in which grip and welding operations are sequentially performed.

The multi-function and multi-vehicle-type common-use robot apparatus 100 according to an exemplary embodiment of the present invention includes the moving device capable of moving the welding and part-holding common-use units 150 to correspond to variations in part size for various vehicle types, and the welding tips 155 of the welding and part-holding common-use units 150 are provided as a swivel type for common use among various parts of multiple vehicle types. Therefore, the common-use unit 150 serves as a multi-function device functioning as both a gripper and a welder, and also serves as a multi-vehicle-type common-use device available for common use in vehicle body assembling processes of various vehicle types, such that the common-use unit 150 may be usefully used in mixed production of various vehicle types.

Moreover, according to an exemplary embodiment of the present invention, when compared to a conventional case where an individual dedicated apparatus is provided, the overall configuration of a system is simplified, and problems of reconstruction and manufacturing of an apparatus in input of a new vehicle type and cost increase caused by reconstruction and manufacturing may be solved, thus reducing investment cost.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A multi-function and multi-vehicle-type common-use robot apparatus comprising:
a robot;
a frame attached to an arm of the robot;
a plurality of sliders assembled to the frame to slide in a predetermined direction; and
a common-use unit which includes an upper welding gun, a lower welding gun, and a component that performs a part-holding gripper and which is mounted on each slider, such that a position of the common-use unit is controlled in the frame.

2. The multi-function and multi-vehicle-type common-use robot apparatus of claim 1, further comprising a moving device for moving each slider to a target position to control a position of the slider according to a control signal of a control panel.

3. The multi-function and multi-vehicle-type common-use robot apparatus of claim 1, wherein the component that performs the part-holding gripper includes the upper welding gun and the lower welding gun, and wherein the upper welding gun and the lower welding gun perform the part-holding gripper by simultaneously pressurizing and fixing a vehicle body part in both sides thereof.

4. The multi-function and multi-vehicle-type common-use robot apparatus of claim 1, wherein a welding tip of each of the upper welding gun and the lower welding gun of the common-use unit performs the part-holding gripper as well as a spot welding.

5. The multi-function and multi-vehicle-type common-use robot apparatus of claim 4, wherein the welding tip of the upper welding gun is installed to rotate according to angle and shape of the vehicle body part.

6. The multi-function and multi-vehicle-type common-use robot apparatus of claim 1, wherein the welding tip of the upper welding gun comprises a rotatably coupled rotating pad.

7. The multi-function and multi-vehicle-type common-use robot apparatus of claim 5, wherein the welding tip of the upper welding gun is configured by forming an engagement portion in a welding rod of the upper welding gun and rotatably coupling the rotating pad to the engagement portion.

8. The multi-function and multi-vehicle-type common-use robot apparatus of claim 7, wherein the rotating pad is coupled to the engagement portion in a ball-joint structure.

9. The multi-function and multi-vehicle-type common-use robot apparatus of claim 8, wherein the engagement portion is provided in a form of a ball in the ball-joint structure, such that the rotating pad is coupled to the engagement portion in the form of the ball.

10. The multi-function and multi-vehicle-type common-use robot apparatus of claim 4, wherein the welding tip of the lower welding gun is installed to rotate according to angle and shape of a vehicle body part.

11. The multi-function and multi-vehicle-type common-use robot apparatus of claim 10, wherein the welding tip of the lower welding gun comprises a rotatably coupled rotating pad.

12. The multi-function and multi-vehicle-type common-use robot apparatus of claim 11, wherein the welding tip of the lower welding gun is configured by forming an engagement portion in a front end portion of a gun arm of the lower welding gun and rotatably coupling the rotating pad to the engagement portion.

13. The multi-function and multi-vehicle-type common-use robot apparatus of claim 12, wherein the rotating pad is coupled to the engagement portion in a ball-joint structure.

14. The multi-function and multi-vehicle-type common-use robot apparatus of claim 1, wherein the frame is in a shape of ‘⊥’ formed by integrally coupling a first sub-frame disposed long in a vertical direction and a second sub-frame disposed long in a horizontal direction, and
a slider is installed in at least one of the first sub-frame disposed long in the vertical direction and the second sub-frame disposed long in the horizontal direction.

15. The multi-function and multi-vehicle-type common-use robot apparatus of claim 14, wherein a plurality of sliders are installed in the first and second sub-frames disposed long in each direction to slide along a longitudinal direction of the first and second sub-frames, and the common-use unit is mounted integrally in each slider to linearly move.

16. The multi-function and multi-vehicle-type common-use robot apparatus of claim 14, wherein two common-use units are mounted in both sides of the second sub-frame via a first slide to move in the horizontal direction, and
one common-use unit is mounted in the first sub-frame via a second slide to move in the vertical direction,
such that at least three common-use units moving in the horizontal direction and in the vertical direction are provided.

17. The multi-function and multi-vehicle-type common-use robot apparatus of claim 2, wherein the moving device comprises:
a motorized linear cylinder tool for moving the slider; and
a linear motion (LM) guide that is fixedly mounted in the frame and coupled to the slider to guide forward and backward sliding of the slider in driving of the motorized linear cylinder tool.

18. The multi-function and multi-vehicle-type common-use robot apparatus of claim 17, wherein the motorized linear cylinder tool comprises:
a motor that is driving-controlled according to a control signal of the control panel;
a screw shaft that rotates by driving of the motor; and
a cylinder rod coupled to the screw shaft in a state where the slider is mounted in a front end portion to move forward and backward in rotation of the screw shaft.
